(19) United States
(12) Patent Application Publication
(10) Pub. No.: US 2014/0352842 A1
(43) Pub. Date: Dec. 4, 2014

(54) Water Collection System for Temporary Protective Covering

(71) Applicant: Greg McEvilly, Austin, TX (US)

(72) Inventor: Greg McEvilly, Austin, TX (US)

(21) Appl. No.: 14/289,218

(22) Filed: May 28, 2014

Related U.S. Application Data
(60) Provisional application No. 61/827,965, filed on May 28, 2013.

(51) Int. Cl. E04H 15/02; B67C 11/00; E04H 15/54

(52) U.S. Cl. CPC E04H 15/02; E04H 15/54; B67C 11/00
USPC 141/69; 141/98

(57) ABSTRACT

A to a temporary protective overhead covering that comprises or is configured as a water collection system. The subject invention can be used to collect water from a variety of sources including, for example, rain, water spray or dew. A filter screen in the form of a mesh barrier used to prevent debris larger than the screen size from entering an associated water collection vessel is also disclosed.

### FIELD OF THE INVENTION

This invention relates to a temporary or semi-permanent protective overhead covering for a hammock, tent, or other shelter that is typically used for recreation, hiking, camping, hunting, fishing, or the like, or in cases of emergency or in disaster relief applications. More particularly, the invention relates to a temporary protective overhead covering that comprises or is configured as a water collection system. The subject invention can be used to collect water from a variety of sources including, for example, rain, water spray or dew. A filter screen to prevent debris larger than the screen size from entering an associated water collection vessel is also disclosed.

### DESCRIPTION OF RELATED ART

Various devices for collecting and funneling rain water into a collection vessel have previously been disclosed. Such devices are not, however, believed to embody elements that provide all the functional advantages of the present invention.

### SUMMARY OF THE INVENTION

This invention can be embodied in a temporary or semi-permanent protective overhead covering for a hammock, tent, or other shelter that is used, for example, for recreation, hiking, camping, hunting, fishing, or the like, or in cases of emergency or in disaster relief applications. In a preferred embodiment, the invention relates to a temporary protective overhead covering that comprises or is configured as a water collection system. The subject invention can be used to collect water from a variety of sources including, for example, rain, water spray or dew. A filter screen to prevent debris larger than the screen size from entering an associated water collection vessel is also disclosed.

A water collection system is disclosed that comprises a protective cover having a higher portion, a lower portion and at least one water collection surface; at least one tensioning device that can be selectively used to impart curvature to the water collection surface to increase the water collection capability of the water collection surface; at least one funnel formed adjacent to at least one edge of the water collection surface and configured to receive water into the funnel from the water collection surface; and at least one fitting cooperatively engaging the at least one funnel, the fitting being configured to selectively enable the discharge or transfer of water from the funnel into an external receptacle.

### BRIEF DESCRIPTION OF THE DRAWINGS

The apparatus of the invention is further described and explained in relation to the following drawings wherein:

FIG. 1 is a top front perspective view of one embodiment of the invention, which is configured as a four-corned canopy supported by a line, and embodies preferred elements of the water-collection system of the invention;

FIG. 2 is an enlarged detail perspective view of one corner of the canopy of FIG. 1, further comprising a water collection funnel of the invention;

FIG. 3 is a cross-sectional front elevation view taken along line 3-3 of FIG. 2;

FIG. 4 is a cross-sectional elevation view taken along line 4-4 of FIG. 3;

FIG. 5 is a top plan view of an alternate embodiment of a temporary protective cover of the invention having six sides and six attachment or tie-down points or corners, with four of the six corners being configured for use in the water collection system of the invention; and

FIG. 6 is a front elevation view, partially in cross-section, of one embodiment of a fitting that is satisfactory for use in attaching a water collection funnel of the invention to a water bottle, hose or other water storage receptacle to store water that is collected as runoff from the top of the protective cover.

### DESCRIPTION OF THE PREFERRED EMBODIMENTS

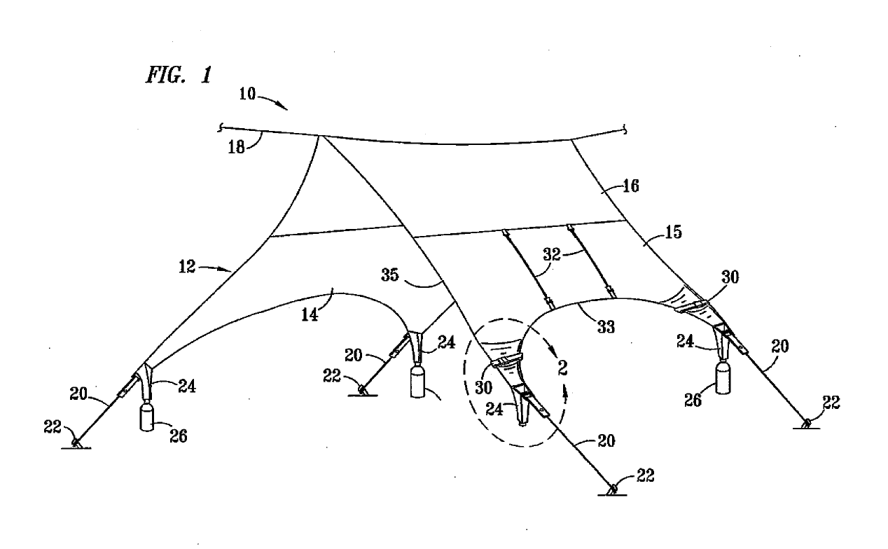

Referring to FIG. 1, protective cover 12 is depicted as being substantially rectangular, with two opposed concave side edges and having four corners, with each corner having a tie-down strap 20 that is staked or otherwise attached to an underlying support surface 22 to spread and hold protective cover 12 in tension relative to line 18 extending beneath the centrally disposed portion of protective cover 12 and from which protective cover 12 is suspended. Protective cover 12 is satisfactorily made from a foldable material, preferably a water repellent textile or a fiber-reinforced plastic sheet, and can be a continuous web or can be fabricated from a plurality of smaller panels such as panels 14, 15, 16. Where fabricated from a plurality of smaller panels, the seams between adjacent panels are also desirably water repellent.

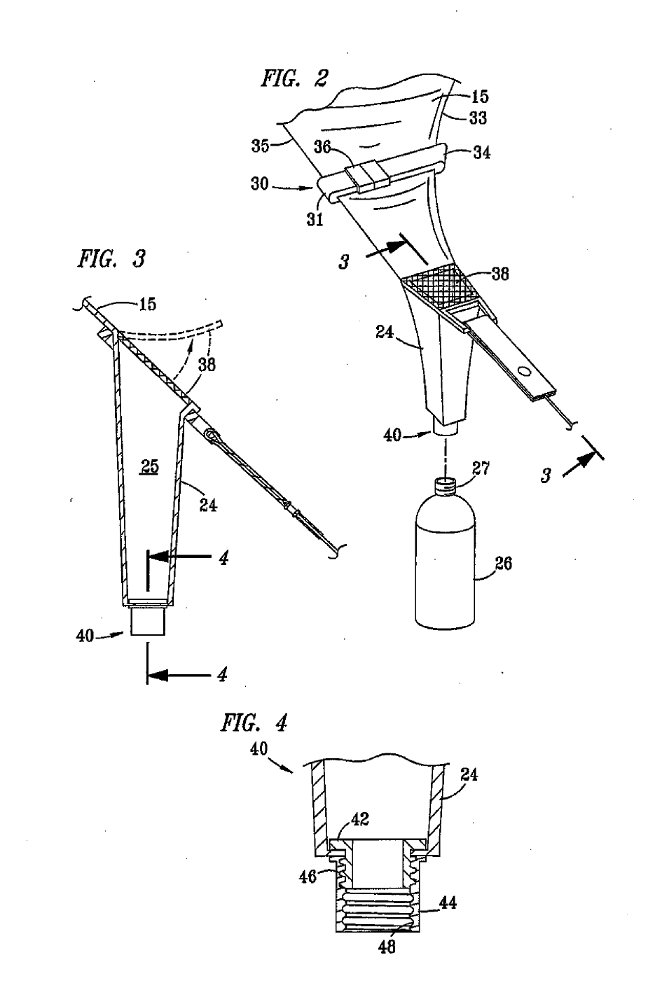

As depicted in FIGS. 1 and 2, a funnel 24 is suspended from the web section of panel 15 that is disposed between edges 33, 35 upwardly of each of the four tie-down points at the corners of protective cover 12. Buckled strap 30 comprising strap sections 31, 34 joined by adjustable buckle 36 joins laterally disposed points of edges 33, 35 and is desirably adjustable in length to pull edges 33, 35 upwardly, thereby forming a shallow trough above each funnel 24 to direct water flowing downwardly over protective cover 12 into the top of funnel 24. Similarly, optional adjustable-length tensioning lines 32 can be provided along the sides of protective cover 12 to curl an edge such as edge 33 upwardly to facilitate the collection of water that would otherwise flow downwardly off the edge.

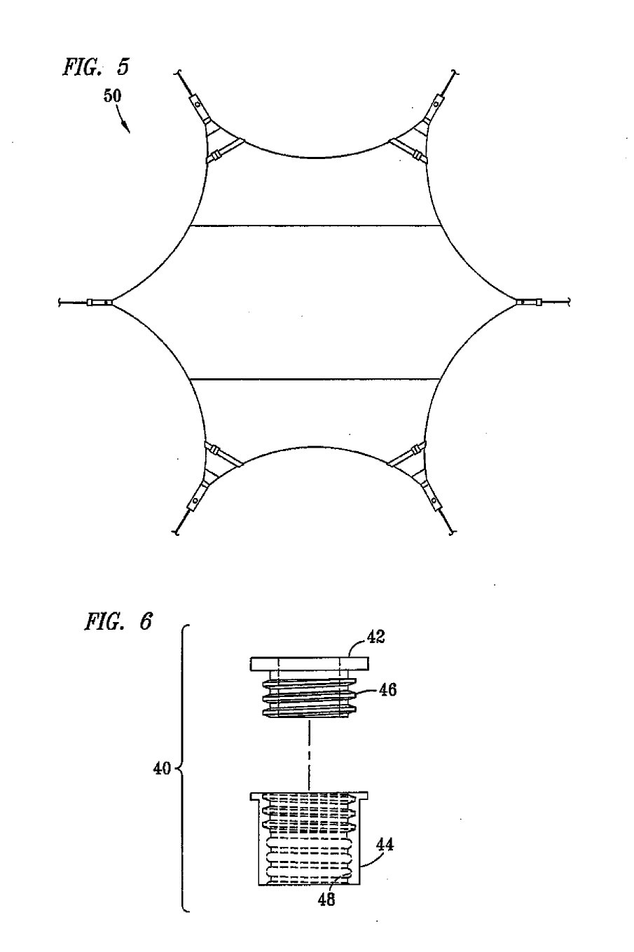

Referring to FIG. 5, protective cover 50 is illustrative of another embodiment of the invention having six concave scallops cooperatively defining six points or corners, wherein two diametrically opposed corners can be tied off to external structures (not shown), thereby eliminating the need for a single line over which the cover is folded prior to tying down the corners as in FIG. 1.

Referring to FIGS. 2-3, each of funnels 24, like protective cover 12, is desirably made of one or a plurality of sections of the same or a similar foldable, water-repellent material such as for example, a waterproofed textile or a fiber-reinforced plastic sheet. According to one preferred embodiment of the invention, a portion near the end of each corner can be folded downwardly to serve as the back wall of funnel 24. Funnel 24 can have any cross-sectional configuration, such as for example, rectangular, circular, or any other closed, regular or irregular, curvilinear or polygonal shape. A filter in the form of a mesh cover or barrier 38 can be provided across the open top of each funnel 24 to help catch debris that might otherwise be washed by a water flow off the upwardly facing surface of protective cover 12 and into funnel 24. The degree to which a water flow is filtered by mesh barrier 38 depends upon the shape and cross-sectional area of the openings through the mesh in relation to the particle size of the debris. Too fine a mesh can hinder the flow of water into the funnel 24 through mesh barrier 38.

According to one preferred embodiment of the invention, as best seen in FIG. 3, mesh barrier 38 is desirably sewn or otherwise affixed in substantially fixed relation to one side or portion of the top edge of funnel 24 so that the remainder of mesh barrier 38 can be folded upwardly to permit access by the user to the interior space 25 of funnel 24. This access to the interior of each funnel 24 permits a user to change the fitting 40 at the bottom of each funnel 24 through which water flowing off of protective cover 12 flows downwardly to exit through the bottom of funnel 24.

Referring to FIGS. 2-4 and 6, fitting 40 is desirably provided in the bottom of each funnel 24 to assist in connecting the funnel to a water bottle 26 or other receptacle to serve as a collection and/or storage vessel for the collected water. Fitting 40 can be satisfactorily made of a moldable polymeric resin such as polyethylene, although other similarly effective materials, including for example metals and rubbery materials, can also be used.

According to one satisfactory embodiment of the invention, fitting 40 further comprises top portion 42 and bottom portion 44. Top portion 42 of fitting 40 preferably comprises a substantially cylindrical sidewall with a tubular bore that projects downwardly through a hole disposed in the bottom of funnel 24. A larger-diameter, radially projecting, annular flange, configured to contact and provide sealing engagement with a portion of the material from which funnel 24 is constructed, surrounds the top opening of top portion 42. The downwardly projecting cylindrical sidewall desirably comprises male threads 46 that are cooperatively engageable with female threads disposed in the top half of bottom portion 44. A smaller annular flange preferably surrounds the top opening of bottom portion 44 of fitting 40. When bottom portion 44 of fitting 40 is threaded onto the male threaded section of top portion, the material of funnel 24 that is disposed around the opening between the two halves of fitting 40 desirably forms a fabric washer between the two opposed flange members. The lower half of bottom portion 44 desirably comprises female threads configured to cooperatively engage the male threaded top opening of a conventional water bottle having 28 mm threads, although it will be appreciated by those of ordinary skill in the art upon reading this disclosure that other thread sizes are similarly useful for attaching a water collection receptacle to the underside of a funnel 24 of protective cover 12.

While the apparatus of the invention is disclosed here in relation to some preferred embodiments, it will be appreciated that other embodiments of various elements can also be used within the scope of the invention. For example, although the material from which each funnel is made may not be totally impermeable to fluid leakage, a valve or stopcock can be provided as part of a fitting installed in the bottom of each funnel 24 to hold runoff water temporarily in the funnel 24. Thus, if only one bottle is available to collect water caught in several funnels 24 attached to one or more protective covers 12, water can be held inside the funnels until such time as a water bottle 26 can be attached and the water can be collected by opening the valve or stopcock. The shape, placement and configuration of the funnels can be varied according to the type, size and shape of the protective cover, and the manner in which it is supported. Similarly, the shape of the protective cover 12 and the number, configuration and placement of tensioning straps can be varied to adjust the water collection capability of the device. The type, shape, porosity and material used as a filter screen can also be varied, and different or multiple filter screens can be used to provide specially desired objectives and results. Hoses and manifolds with quick connect and disconnect fittings can be attached or attachable to the individual water collection funnels to redirect collected water to a desired receptacle or container.

The present invention will enable users to capture, collect and store water for immediate and future use. Whether applied to sporting or recreational uses, or to disaster and emergency relief situations, the subject water collection system will afford users with a better opportunity to capture and use water that was previously wasted or unavailable.

Other alterations and modifications of the invention will likewise become apparent to those of ordinary skill in the art upon reading this specification in view of the accompanying drawings, and it is intended that the scope of the invention disclosed herein be limited only by the broadest interpretation of the appended claims to which the inventor(s) and/or Applicant are legally entitled.

What is claimed is:

1. A water collection system comprising:
a protective cover having a higher portion, a lower portion and at least one water collection surface;
at least one tensioning device that can be selectively used to impart curvature to the water collection surface to increase the water collection capability of the water collection surface;
at least one funnel formed adjacent to at least one edge of the water collection surface and configured to receive water into the funnel from the water collection surface; and
at least one fitting cooperatively engaging the at least one funnel, the fitting being configured to selectively enable the transfer of water from the funnel into an external receptacle.

2. The water collection system of claim 1 wherein the external receptacle is a water bottle.

3. The water collection system of claim 2 wherein the water bottle threadedly engages the fitting.

4. The water collection system of claim 1 wherein the protective cover comprises a plurality of corner sections, at least one of which further comprises at least one funnel.

5. The water collection system of claim 1, further comprising a mesh barrier to prevent debris from entering the external receptacle.
